(19) United States
(12) Patent Application Publication
(10) Pub. No.: US 2023/0369881 A1
(43) Pub. Date: Nov. 16, 2023

(54) CAPACITIVE LOAD CHARGING SYSTEM

(71) Applicant: TEXAS INSTRUMENTS INCORPORATED, Dallas, TX (US)

(72) Inventors: Dilip Jain, Plano, TX (US); Rakeshbabu Pangaloori, Plano, TX (US)

(21) Appl. No.: 18/192,871

(22) Filed: Mar. 30, 2023

(30) Foreign Application Priority Data
May 11, 2022 (IN) 202241027060

(51) Int. Cl. H02J 7/34; B60L 50/40

(52) U.S. Cl. CPC H02J 7/345; B60L 50/40

(57) ABSTRACT

A system includes a transistor having a control input and first and second current terminals. The system also includes a diode coupled between the second current terminal and a supply reference terminal. An electronics unit has a supply voltage terminal. The electronics unit has a capacitor coupled between the supply voltage terminal and the supply reference terminal. A cable has a length of at least one meter and is coupled between the transistor and the electronics unit. The cable has a parasitic inductance. A controller has a current sense input and a control output. The current sense input is coupled to the first current terminal, and the control output is coupled to the control input. The controller is configured to repeatedly turn on and off the transistor to charge the capacitor. Each time the transistor is turned off, inductive energy in the parasitic inductance continues to charge the capacitor.

### CROSS-REFERENCE TO RELATED APPLICATIONS

This application claims priority to India Provisional Application No. 202241027060, filed May 11, 2022, which is hereby incorporated by reference.

### BACKGROUND

It is a common practice to have a capacitor coupled between a power supply input terminal of an electrical load and the supply reference terminal (e.g., ground) to reduce undesirable power supply voltage fluctuations. Such capacitors are initially charged during a power-up event of the system containing such electrical loads. An amount of time is expended to charge such capacitors. The amount of charge time is, among other factors, a function of the magnitude of the capacitance of the capacitor. All else being equal, larger capacitors take more time to charge than smaller capacitors.

### SUMMARY

In at least one example, a system includes a transistor having a control input and first and second current terminals. The system also includes a diode coupled between the second current terminal and a supply reference terminal. An electronics unit has a supply voltage terminal. The electronics unit has a capacitor coupled between the supply voltage terminal and the supply reference terminal. A cable has a length of at least one meter and is coupled between the transistor and the electronics unit. The cable has a parasitic inductance. A controller has a current sense input and a control output. The current sense input is coupled to the first current terminal, and the control output is coupled to the control input. The controller is configured to repeatedly turn on and off the transistor to charge the capacitor. Each time the transistor is turned off, inductive energy in the parasitic inductance continues to charge the capacitor.

A method for charging a capacitor includes (a) turning on a transistor coupled to the capacitor, (b) determining that a current through the transistor to the capacitor has reached a threshold, and (c) in response to determining that the current has reached the threshold, turning off the transistor and starting a timer. The method further includes repeating (a), (b), and (c) upon expiration of the timer.

### BRIEF DESCRIPTION OF THE DRAWINGS

FIG. 1 is a schematic diagram of an example system including fuses to protect against excessive current levels between a battery and electronic units.

FIG. 2 is a schematic diagram of another example system including a solid-state switch instead of a fuse.

FIG. 3 is a schematic diagram of yet another example system including a solid-state switch and a diode to permit inductive energy to continue charging a capacitor within an electronic unit.

FIG. 4 is a flowchart illustrating the operation of the controller of FIG. 6, in accordance with an example.

FIG. 5 are graphs illustrating the operation of the system of FIG. 3, in accordance with an example.

FIG. 6 is a block diagram of an example controller usable in the system of FIG. 3

### DETAILED DESCRIPTION

The same reference numbers or other reference designators are used in the drawings to designate the same or similar (either by function and/or structure) features.

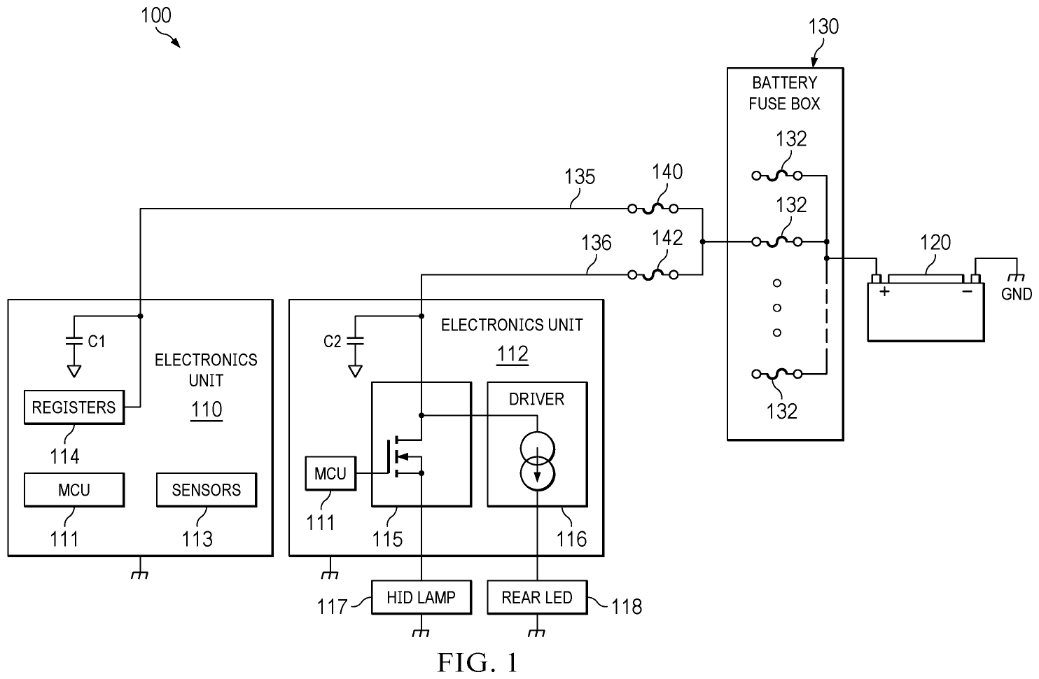

FIG. 1 is a schematic diagram of a system 100 which includes one or more electronics units 110 and 112 coupled to a battery 120. The battery 120 provides an operating voltage and current for each of the electronics units 110 and 112. One or more fuses are coupled between the battery 120 and the electronics units 110 and 112. In FIG. 1, a battery fuse box 130 is included which includes individual fuses 132. An electrical cable couples each electronics unit to the battery fuse box 130. For example, electrical cable 135 couples the battery fuse box 130 to electronics units 110, and electrical cable 136 couples electronics unit 112 to the battery fuse box. A fuse may be included within or coupled to each electrical cable. For example, fuse 140 is associated with electrical cable 135 and electrical unit 110, and current to the electronics unit 110 flows through fuse 140. Similarly, fuse 142 is associated with electrical cable 136 and electrical unit 112, and current to the electronics unit 112 flows through fuse 142. The fuses 132, 140, and 142 in FIG. 1 can be melting fuses in which an excessive current through a fuse overheats the fuse causing it to melt, which thereby interrupts the flow of current.

A variety of applications are possible for system 100. For example, system 100 may be part of a vehicle (e.g., automobile, truck, bus, airplane, etc.). In the context of an automobile, electronics unit 110 may be an emissions controller and electronics unit 112 may be a body control module. Electronics units 110 and 112 may include a variety of components. For example, electronics unit 110 includes microcontroller unit (MCU) 111, sensors 113, and registers 114. Electronics unit 112 includes an MCU 111, drivers 115 and 116 to turn on and provide current for lights (e.g., light emitting diodes) 117 and 118, respectively. An automobile may include one or more, and typically many, electronics units that receive their operating power from the battery 120.

Each electronics unit also may include a capacitor coupled between its power supply terminal input and a supply reference terminal (e.g., ground). For example, electronics unit 110 includes capacitor C1, and electronics unit 112 includes capacitor C2. As described above, such capacitors reduce ripple on the supply voltage from the battery 120 to the circuitry in each electronics unit. Such capacitors may be relatively large (e.g., 5 mF).

A vehicle may have numerous fuses (e.g., more than 80 fuses) distributed across multiple fuse boxes 130. The electrical cables 135 and 136 should be sized in terms of their thickness (cross-sectional area) to safely conduct the maximum amount of current that a fuse can conduct without melting the fuse. For example, for a fuse rated for 20 amperes (A), the electrical cable should be sized to safely conduct at least up to 20A of current. However, the current rating of melting fuses has considerable variability. For example, a 20A fuse may not melt until its current reaches 25A. Because of such variability, the electrical cables in a vehicle are generally sized to accommodate more current than the stated current ratings of the fuses. Larger current capacity cables means that the cross-sectional areas of the cables are larger and thus occupy more space in a vehicle, and the cables are also heavier.

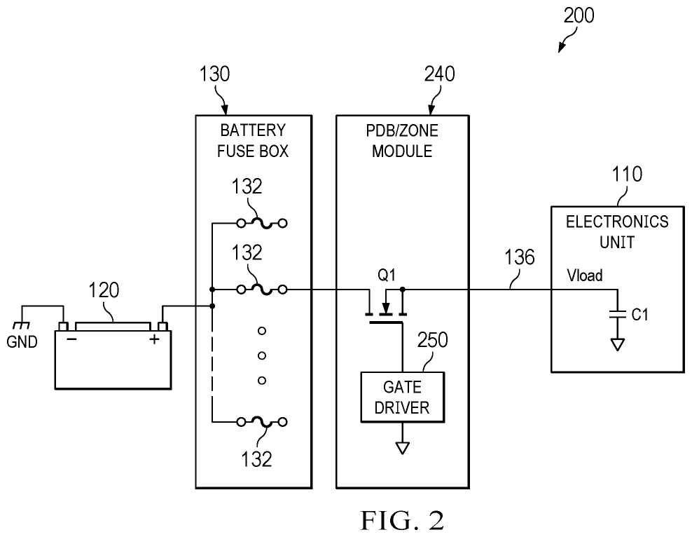

To address the problems described above, one or more of the melting fuses in an automobile can be replaced with a solid-state switch. For example, FIG. 2 is a schematic diagram of a system 200 in which a solid-state transistor, e.g., transistor Q1, is included instead of a melting fuse (e.g., fuse 140 in FIG. 1). Any or all the fuses can be replaced with solid-state switches. The solid-state transistors may be field effect transistors (FETs). A gate driver 250 is coupled to the control input (e.g., gate) of transistor Q1. The current through transistor Q1 can be precisely monitored by the gate driver 250, and the gate driver 250 can turn off transistor Q1 in response to the current through the transistor exceeding a predefined current (e.g., 20A). Because there is less variability in the over-current threshold implemented by the gate driver 250 than the current which melts a fuse, the electrical cables coupled between the solid-state switches and the electronics units can use smaller gauge wires than would otherwise have been the case with melting fuses. The solid-state transistors Q1 and their associated gate drivers 250 may be included as part of a power distribution box/zone module 240 in a vehicle.

While the use of transistors as switches instead of melting fuses allows for smaller and lighter weight cabling to be used in a vehicle, the use of such transistors may create a problem in which the in-rush current through the transistor to charge the capacitor C1 may damage the transistor. For example, with the vehicle off, the gate driver 250 may be off, and if the gate driver 250 is off, transistor Q1 also is off. With transistor Q1 off, capacitor C1 may be discharged. Response to turning the vehicle on, gate driver 250 turns on transistor Q1. Transistor Q1 is a large enough transistor (size measured in terms of the ratio of channel width (W) to channel length (L)) to accommodate the load current from the battery 120 to the electronics unit 110 (e.g., 20A, 50A, etc.). In some examples, multiple transistors are coupled in parallel to accommodate the load current. Because transistor Q1 is large, the on-resistance (Rdson) of transistor Q1 is fairly low (e.g., 100 milli-ohms). The impedance of a capacitor is inversely related to frequency—at high frequencies, a capacitor represents an impedance close to a short-circuit. When gate driver 250 turns on transistor Q1, the voltage across capacitor C1 (Vload) increases rapidly from 0V to 12V. Gate driver 250 turns on transistor Q1 fast enough that the sudden increase in the voltage on capacitor C1 is relatively high frequency event, which renders the impedance of capacitor C1 very low. Accordingly, the impedance between the battery 110 and the ECU through the transistor Q1 and capacitor C1 is low enough that the inrush current from the battery through transistor Q1 may become high enough to damage transistor Q1.

One possible solution the large inrush current through transistor Q1 is for the gate driver 250 to turn on transistor Q1 slowly. Doing so will permit capacitor C1 to charge to the battery's voltage with a smaller peak current magnitude. However, slowly turning on transistor Q1 will result in capacitor C1 taking longer to charge to its target fully charged voltage Vcharge (e.g., an automobile battery's voltage of 12V), and for at least some applications, it may be desirable or necessary to charge the capacitor to the battery's voltage within a shorter period of time. In one example, capacitor C1 may be 5 mF and the battery's voltage may be 12V, and the maximum permitted time to charge the 5 mF capacitor from 0V to 12V is 10 milliseconds (ms). Reducing the slew rate at which transistor Q1 turns on may not permit the capacitor to charge to its target voltage quickly enough.

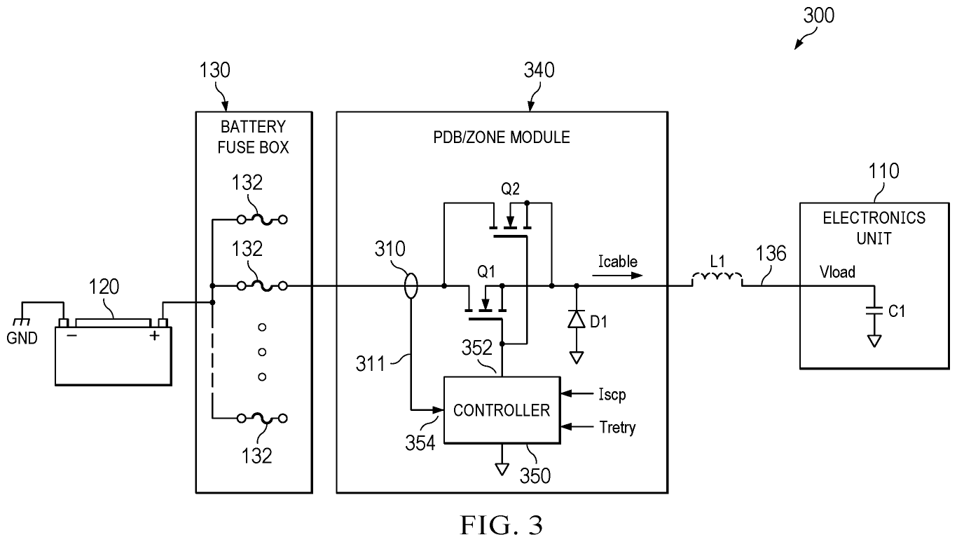

FIG. 3 is a schematic diagram of a system 300 that addresses the inrush current problem described above with regard to FIG. 2. System 300 includes a power distribution box/zone module 340 coupled between the battery fuse box 130 and an electronics unit (e.g., electronics unit 110). As mentioned above, cable 136 interconnects the power distribution box/zone module 340 and electronics unit 110. The length of cable 136 may be substantial. For example, the length of cable 136 may be in the range of 1 meter to 3 meters. The electrical cable 136 includes parasitic inductance L1. For 8 AWG electrical cable 136, the cable includes a parasitic inductance of 1.5 micro-Henry's per meter. As described below, the system 300 takes advantage of the energy stored in the parasitic inductance of electrical cable 136 to continue to assist in charging capacitor C1.

The power distribution/zone module 340 includes a controller 350, transistors Q1 and Q2, and a diode D1. Transistors Q1 and Q2 are n-channel FETs (NFETS) in this example. The gates of transistors Q1 are coupled together, the sources are coupled together, and the drains are coupled together. Transistors Q1 and Q2 are coupled in parallel such that current Icable from the battery 120 to the electronics unit 110 divides between the two transistors and neither transistor need conduct the full level of current Icable.

The controller has a control output 352 and a current sense input 354. The gates of transistors Q1 and Q2 are coupled to the control output 352. A current sense circuit 310 is coupled to the current sense input and generates a signal 311 indicative of the magnitude of the current Icable. The current sense is coupled to the drain of transistor Q1. In one example, the current sense circuit 310 includes a resistor (not shown) having a relatively low resistance (e.g., 0.001 ohms). The voltage across the resistor of the current sense circuit 310 is proportional to current Icable.

The controller 350 may be programmable. The values that are programmable for the controller 350 include a short circuit protection threshold Iscp and a retry time period value Tretry. The short circuit protection threshold Iscp represents the maximum current level of current Icable. The controller 350 responds to a detection (via current sense circuit 310) that current Icable exceeds the short circuit protection threshold Iscp by turning off transistors Q1 and Q2. The controller 350 may also implement an automatic retry capability. Upon detecting that current Icable exceeds the short circuit protection threshold Iscp, a timer internal to the controller 350 also initializes. The time period implemented by the timer is the Tretry time period. Upon expiration of the timer (Tretry time period following the controller 350 turning off transistors Q1 and Q2), the controller again turns on transistors Q1 and Q2. If the Icable again exceeds the short circuit protection threshold Iscp, the controller 350 again turns off transistors Q1 and Q2, and the timer is started again for the Tretry time period. Upon expiration of the timer, the controller again turns on transistors Q1 and Q2, and the process repeats as long as the current Icable continues to exceed the short circuit protection threshold Iscp.

During power-up or initialization of the system 300 (e.g., the vehicle's ignition is on), the controller 350 repeatedly turns on and off transistors Q1 and Q2 in a controlled manner through a series of switching cycles 501a, 501b, 501c, 501d, and 501e (although five switching cycles are shown, fewer or more than five switching cycles may be implemented), as described below, to charge capacitor C1 in the electronics unit 110. During normal, steady-state operation, capacitor C1 is fully charged and the controller 350 maintains transistors Q1 and Q2 in the on state, thereby permitting the voltage and current from the battery 120 to power the electronics unit 110. As described above, if the controller 350 detects that the current Icable exceeds the short circuit protection threshold Iscp, the controller turns off the transistors Q1 and Q2, and implements the auto retry capability described above.

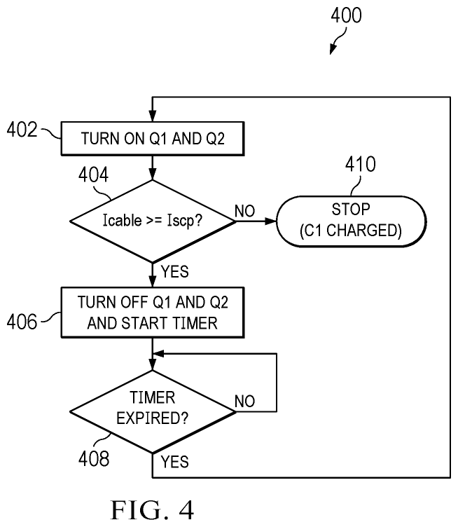

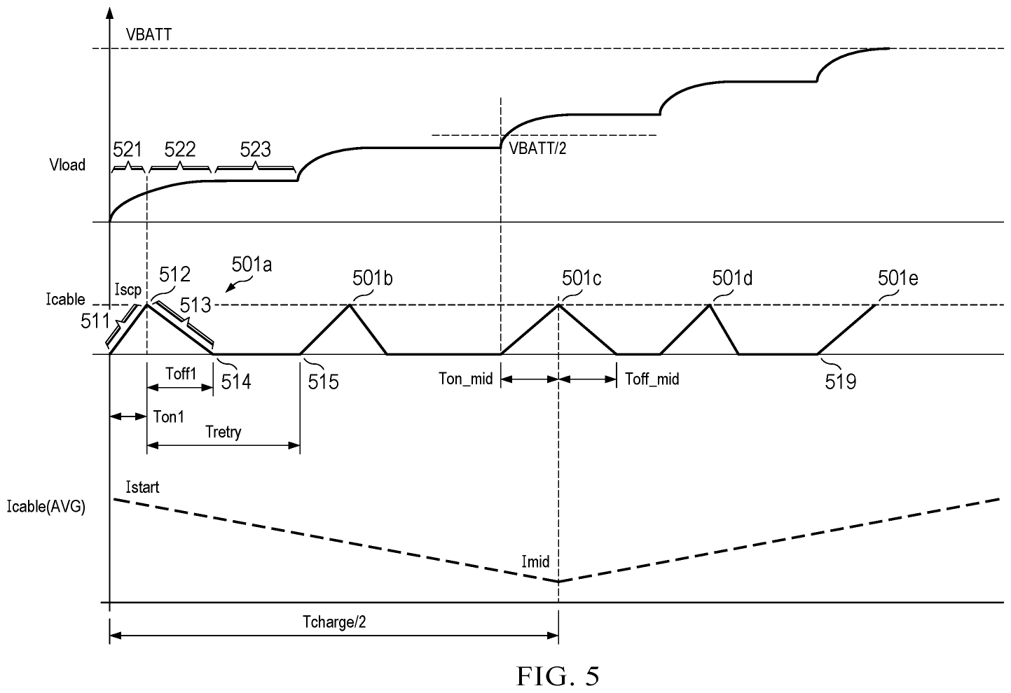

The short circuit protection and auto retry capability of the controller 350 are also used to charge capacitor C1. The charging process for capacitor C 1 is described with reference to system 300 in FIG. 3 and the corresponding flowchart 400 of FIG. 4 and waveforms of FIG. 5. The flowchart 400 of FIG. 4 shows an example of the steps that may be performed by controller 350. The example waveforms in FIG. 5 include the voltage across capacitor C1 (Vload), the current Icable, and the average of that current Icable(avg) during each switching cycle 501a-501e.

Referring to FIG. 4, at step 402, the controller 350 turns on transistors Q1 and Q2, thereby causing current to flow from the battery 120 through the transistors Q1 and Q2, the parasitic capacitance L1 of electrical cable 136 and to capacitor C1 to charge the capacitor. Energy is stored in the magnetic field of the cable's parasitic inductance. In response to transistors Q1 and Q2 being on, current Icable increases as shown at 511 in FIG. 5. Also, voltage Vload (voltage across capacitor C1) increases as shown at 521.

Current Icable reaches the short circuit protection threshold Iscp at 512. At step 404 in FIG. 4, controller 350 detects whether current Icable has reaches the short circuit protection threshold Iscp by, for example, comparing the magnitude of signal 311 from the current sense circuit 310 (which may be a voltage proportional to current Icable) to the short circuit protection threshold Iscp. In response to detecting that current Icable has reached the short circuit protection threshold Iscp (the “Yes” branch from step 404), at step 406, controller 350 turns off transistors Q1 and Q2 and starts its internal timer. As long as the timer has not expired, control loops back to step 408.

Turning off transistors Q1 and Q2 ceases the flow of current through from the battery 120 through the transistors to capacitor C1. However, the inductive energy previously stored in parasitic inductance L1 of the electrical cable 136 dissipates into capacitor C1 to continue charging the capacitor. The voltage Vload across capacitor C1 continues to increase as shown at 522 in FIG. 5, while the current Icable decreases as the inductive energy of parasitic inductance L1 dissipates. Eventually, the inductive energy of parasitic inductance L1 fully dissipates at point 514. With the parasitic inductance's energy having been fully depleted to assist in further charging capacitor C1, the voltage Vload across capacitor C1 remains relatively constant as shown at 523. Response to the expiration of the timer (the “Yes” branch from step 408), control loops to step 402 at which controller 350 again turns on transistors Q1 and Q2 at point 515 in FIG. 5, and the process repeats. With each on/off cycle of transistors Q1 and Q2, the voltage Vload across capacitor C1 increases. The steps of FIG. 4 repeat until voltage Vload reaches the level of the voltage of battery 120. When voltage Vload reaches the level of the voltage of battery 120, current Icable is a function of the current draw of the circuitry within the electronics unit 110 and not a function of charge current to capacitor C1. Accordingly, after transistors Q1 and Q2 are turned on at point 519, voltage Vload reaches the battery voltage and current Icable will not reach the short circuit protection threshold Iscp, and thus the controller 350 will take the “No” branch from step 404. The charging process of capacitor C1 stops at 410.

As mentioned above, the short circuit protection threshold Iscp and the retry time period Tretry are programmable. The short circuit protection threshold Iscp should be set to a level that is higher than the maximum permitted cable current Icable during normal operation, which is a level above which the system should turn off the transistors because a possible short circuit condition may have occurred. For example, if the maximum permitted cable current Icable for the electronics unit 110 is 50 A, the short circuit protection threshold Iscp should be set above 50A, for example, 60 A.

The tretry value should be short enough that capacitor C1 can be charged to its target voltage (Vcharge) within the prescribed time period, Tcharge. The target charge voltage Vcharge and the prescribed charging time period are application-specific and can be calculated as follows. As shown in FIG. 5, capacitor C1 incrementally charges through a series of switching cycles 501a, 501b, 501c, 501d, and 501e cycles form 0V to its target charge voltage Vcharge. Within each cycle, controller 350 turns on transistors Q1 and Q2 for an on-time Ton. The controller 350 then turns off the transistors, during part of which, Toff, the inductive energy in the cable's parasitic inductance continues to charge the capacitor as described above. The Tretry period of time starts upon the controller 350 turning off transistors.

The waveform Icable(avg) represents the average current Icable during each switching cycle 501a-501e. The initial value of Icable(avg) is denoted as Istart, and the values of Ton and Toff for the first switching cycle are denoted Ton1 and Toff1, respectively. When the capacitor voltage has charged to one-half of its target voltage (Vcharge/2), the values of Ton and Toff are equal to each other. Switching cycle 501c denotes the middle (mid) switching cycle for which Ton_mid equals Toff_mid. The value of Icable(avg) for the middle switching cycle 501c is denoted as Imid.

An example of the relationship between Istart, Imid, Tcharge, C1, and Vcharge is:

$$\frac{Istart + Imid}{3} \times \frac{Tcharge}{2} = C 1 \times \frac{Vcharge}{2} \qquad ( Eq . 1 )$$

$$where :$$

$$Istart = \frac{Iscp \times ( Ton 1 + Toff 1 )}{2 \times ( Ton 1 + Tretry )} \qquad ( Eq . 2 )$$

$$Imid = \frac{Iscp \times 2 \times Ton\_mid}{2 \times ( Ton\_mid + Tretry )} \qquad ( Eq . 3 )$$

$$Ton 1 = \frac{Lcable \times Iscp}{Vcharge} \qquad ( Eq . 4 )$$

$$Toff 1 = \frac{Lcable \times Iscp}{V\_D1} \qquad ( Eq . 5 )$$

$$Ton\_mid = \frac{Lcable \times Iscp}{Vcharge / 2} \qquad ( Eq . 6 )$$

In Eq. (5), V_D1 represents the forward bias voltage of diode D1 when the parasitic inductance L1 is charging capacitor C1 during the Toff time periods.

In the example of an automobile, capacitor C1 should be charged from 0V to the battery's voltage, which is typically 12V (Vcharge equals 12V). Further, in an example, capacitor C1 may be 5 mF and should be fully charged within 10 ms (Tcharge equals 10 ms). Assuming the length of electrical cable 136 is 1.5 m and includes 8 AWG wiring (1.5 mH/m), Lcable is 2.25 mH. For a 50A maximum current load for current Icable, the short circuit protection threshold Iscp may be set at 60A. Plugging in these values into the equations above and solving for Tretry resulting in a value of Tretry of 200 microseconds. This means that the controller 350 should implement a Tretry time period for its internal timer of less than or equal to 200 microseconds. The value of Tretry should be at least the largest Toff time period, which is Toff1 to allow for the cable's parasitic inductance to fully discharge into capacitor C1 during each switching cycle. For the numerical example above, the minimum value of Tretry is 214 microseconds.

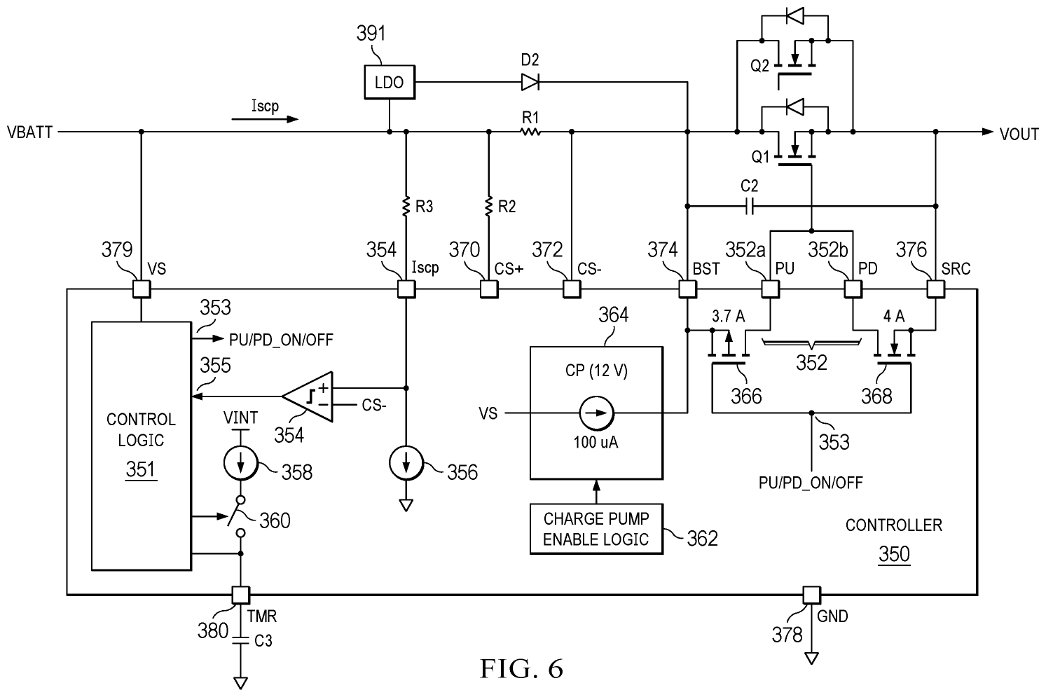

FIG. 6 is a block diagram of an example controller 350. In this example, controller 350 includes control logic 351, a comparator 354, current sources 356, 358, and 364, switch 360, 366, and 368 (e.g., transistors), and charge pump enable logic 362. The controller 350 may be implemented as an integrated circuit (IC) or as discrete components. The controller 350 includes a supply reference terminal 378 (e.g., ground) a supply voltage terminal 379, and additional terminals 354 (mentioned above) 370, 372, 374, 376, and 380. Further, terminals 352a and 352b represent the control output 352, described above. Supply voltage from the battery 120 is coupled to the supply voltage terminal 379, and to a power input of the control logic 351 to power the control logic. Transistor 366 is a p-channel field effect transistor (PFET), and transistor 368 is an NFET. The drain of transistors 366 is coupled to terminal 352a, and the drain of transistor 368 is coupled to terminal 352b. The gates of transistors Q1 and Q2 can be coupled to terminals 352a and 352b.

Control logic 351 outputs a digital signal PU/PD_ON/OFF 353, which is provided to the gates of PFET 366 and NFET 368. Responsive to PU/PD_ON/OFF 353 being logic low, transistor 366 turns on and transistor 368 turns off. Responsive to PU/PD_ON/OFF 353 being logic high, transistor 366 turns off and transistor 368 turns on. Accordingly, only one of transistors 366 and 368 can be on at any point in time. Transistor 366 is a pull-up transistor, which when on, causes transistors Q1 and Q2 to be on. Transistor 368 is a pull-down transistor, which when on, causes transistors Q1 and Q2 to be off. The charge pump enable logic 362 enables current source 364, for example, responsive to the power supply voltage to control logic 351 being above an underlock voltage (UVLO) threshold. Capacitor C2 may be coupled as shown between terminals 374 and 376 and can be charged both by the current source 364 and by current through diode D2. A voltage regulator, for example, low drop-out (LDO) regulator 391 is coupled to the anode of diode D2 and provides a voltage derived from the battery to diode D2. In some examples, the anode of diode D2 can be coupled to the battery without a voltage regulator. The cathode of diode D2 is coupled capacitor C2. The charge on capacitor C2 helps to provide a sufficiently large gate current to transistors Q1 and Q2 to turn on the transistors quickly enough for the given application.

The current sense circuit 310 described above includes resistors R1 and R2 in this example. Resistor R1 has a relatively low resistance (e.g., 0.1 ohms) and is coupled between terminals 370 (via resistor R2) and 372. Comparator 354 has a positive input and a negative input. The positive input is couple to terminal 354, and the negative input is coupled to terminal 372. Resistor R3 represents the programmability of the short circuit protection threshold Iscp for the controller. Current source 356 forces a current (e.g., 15.6 micro-amperes) through resistor R3 to produce a voltage on terminal 354 which is a function of the battery voltage. The magnitude of the short circuit protection threshold Iscp can be a function of the resistance value of resistor R3, and depends on the specific implementation of the controller 350. Accordingly, the short circuit protection threshold Iscp can be programmed by the selection of resistor R3. Comparator 354 compares the voltage on terminal 354 to the voltage on terminal 372, which is a function of the current Icable through resistor R1, and outputs a digital signal 355 to the control logic 351 to indicate whether the current Icable is above or below the short circuit protection threshold Iscp. A logic high assertion of digital signal 355 indicates that Icable is larger than Iscp, and a logic low assertion of digital signal 355 indicates that Icable is not larger than Iscp. Responsive to a logic high assertion of digital signal 355, control logic 351 turns on transistor 368 to turn off transistors Q1 and Q2, as described above.

Capacitor C3 implements the controller's programmability for the timer described above. Current source 358 is switched, via switch 360 controlled by the control logic 351, to capacitor C3. Upon control logic 351 responding to a logic high assertion of digital signal 355, the control logic also closes switch 360, and capacitor C3 begins to charge at a rate that is a function of the capacitance of capacitor C3 and the magnitude of the current from current source 358. The capacitance of capacitor C3 is a function of the current from current source 358, and the function may vary from controller to controller. Larger capacitance values of capacitor C3 result in capacitor C3 charging at a slower rate than smaller capacitance values of capacitor C3. The timer described above may be implemented by the control logic 351 counting the number of times that the voltage on capacitor C3 reaches a threshold set internal to the control logic. The control logic may charge and discharge capacitor C3 multiple times via switch 360 to implement the target Tretry time period.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

Also, in this description, the recitation “based on” means “based at least in part on.” Therefore, if X is based on Y, then X may be a function of Y and any number of other factors.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal”, “node”, “interconnection”, “pin” and “lead” are used interchangeably. Unless specifically stated to the contrary, these terms are generally used to mean an interconnection between or a terminus of a device element, a circuit element, an integrated circuit, a device or other electronics or semiconductor component.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

While the use of particular transistors is described herein, other transistors (or equivalent devices) may be used instead with little or no change to the remaining circuitry. For example, a field effect transistor (“FET”) (such as an n-channel FET (NFET) or a p-channel FET (PFET)), a bipolar junction transistor (BJT—e.g., NPN transistor or PNP transistor), an insulated gate bipolar transistor (IGBT), and/or a junction field effect transistor (JFET) may be used in place of or in conjunction with the devices described herein. The transistors may be depletion mode devices, drain-extended devices, enhancement mode devices, natural transistors or other types of device structure transistors. Furthermore, the devices may be implemented in/over a silicon substrate (Si), a silicon carbide substrate (SiC), a gallium nitride substrate (GaN) or a gallium arsenide substrate (GaAs).

References may be made in the claims to a transistor's control input and its current terminals. In the context of a FET, the control input is the gate, and the current terminals are the drain and source. In the context of a BJT, the control input is the base, and the current terminals are the collector and emitter.

References herein to a FET being “ON” or “enabled” means that the conduction channel of the FET is present and drain current may flow through the FET. References herein to a FET being “OFF” or “disabled” means that the conduction channel is not present so drain current does not flow through the FET. An “OFF” FET, however, may have current flowing through the transistor's body-diode.

Circuits described herein are reconfigurable to include additional or different components to provide functionality at least partially similar to functionality available prior to the component replacement. Components shown as resistors, unless otherwise stated, are generally representative of any one or more elements coupled in series and/or parallel to provide an amount of impedance represented by the resistor shown. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. In this description, unless otherwise stated, “about,” “approximately” or “substantially” preceding a parameter means being within +/−10 percent of that parameter or, if the parameter is zero, a reasonable range of values around zero.

Modifications are possible in the described embodiments, and other embodiments are possible, within the scope of the claims.

What is claimed is:

1. A system, comprising:
a transistor having a control input and first and second current terminals;
a diode coupled between the second current terminal and a supply reference terminal;
an electronics unit having a supply voltage terminal, the electronics unit having a capacitor coupled between the supply voltage terminal and the supply reference terminal;
a cable having a length of at least one meter and coupled between the transistor and the electronics unit, the cable having a parasitic inductance; and
a controller having a current sense input and a control output, the current sense input coupled to the first current terminal, and the control output coupled to the control input, the controller configured to repeatedly turn on and off the transistor to charge the capacitor, wherein each time the transistor is turned off, inductive energy in the parasitic inductance continues to charge the capacitor.

2. The system of claim 1, wherein the transistor is a first transistor, and the system includes a second transistor coupled in parallel with the first transistor.

3. The system of claim 1, wherein the controller configured to:
(a) turn ON the transistor;
(b) determine that a current through the transistor has reached a threshold;
(c) in response to the determination that the current has reached the threshold, turn off the transistor and start a timer; and
(d) upon expiration of the timer, repeat (a), (b), and (c).

4. The system of claim 3, wherein the threshold is programmable and wherein the timer is programmable.

5. The system of claim 3, further comprising an automobile battery coupled to the first current terminal, and the controller is configured to repeatedly perform (a), (b), and (c) until the capacitor is charged to a voltage of the automobile battery.

6. The system of claim 1, wherein the system is an automobile.

7. The system of claim 1, wherein the capacitor is coupled between a supply voltage terminal and a supply reference terminal of an electronics unit.

8. A system, comprising:
a transistor having a control input and first and second current terminals;
a capacitor;
a cable coupled between the transistor and the capacitor; and
a controller having a current sense input and a output, the current sense input coupled to the first current terminal, and the output of the controller coupled to the control input, the controller configured to:
(a) turn on the transistor;
(b) determine that a current through the transistor has reached a threshold;
(c) in response to the determination that the current has reached the threshold, turn OFF the transistor and start a timer; and
(d) upon expiration of the timer, repeat (a), (b), and (c).

9. The system of claim 8, wherein a time period associated with the timer and the threshold are programmable.

10. The system of claim 8, wherein the cable has a length of at least 1 meter.

11. The system of claim 8, wherein the cable includes and 8 AWG conductor and has a length of at least 1 meter.

12. The system of claim 8, further comprising a diode having an anode and a cathode, the anode coupled to the second current terminal and the cathode coupled to a supply reference terminal.

13. The system of claim 8, wherein the system is an automobile.

14. The system of claim 8, further comprising an automobile battery coupled to the first current terminal, and (a), (b), and (c) are repeatedly performed until the capacitor is charged to a voltage of the automobile battery.

15. The system of claim 8, wherein the capacitor is coupled between a supply voltage terminal and a supply reference terminal of an electronics unit.

16. A method for charging a capacitor, the method comprising:
(a) turning on a transistor coupled to the capacitor;
(b) determining that a current through the transistor to the capacitor has reached a threshold;
(c) in response to determining that the current has reached the threshold, turning off the transistor and starting a timer; and
(d) upon expiration of the timer, repeating (a), (b), and (c).

17. The method for charging the capacitor of claim 16, further comprising continuing to charge the capacitor after turning off the transistor using energy stored a magnetic field of a parasitic inductance.

18. The method of claim 16, wherein (a), (b), and (c) are repeatedly performed until the capacitor is charged to a voltage of an automobile battery.

19. The method of claim 16, further comprising programming the threshold.

20. The method of claim 16, further comprising programming a time period associated with the timer.
